(19) United States
(12) Patent Application Publication
(10) Pub. No.: US 2016/0217560 A1
(43) Pub. Date: Jul. 28, 2016

(54) METHOD AND SYSTEM FOR AUTOMATIC DEFORMABLE REGISTRATION

(71) Applicant: KONINKLIJKE PHULIPS N.V., Eindhoven (NL)

(72) Inventors: Amir Mohammad TAHMASEBI MARAGHOOSH, Ridgefield, CT (US); Jochen KRUECKER, Washington, DC (US)

(73) Assignee: Koninkljke Philips N.V.

(21) Appl. No.: 14/917,738

(22) PCT Filed: Sep. 17, 2014
(86) PCT No.: PCT/IB2014/064581

§ 371 Date: Mar. 9, 2016

Related U.S. Application Data
(60) Provisional application No. 61/884,165, filed on Sep. 30, 2013.

(51) Int. Cl. G06T 7/00

(52) U.S. Cl. CPC G06T 7/003; G06T 2207/10132; G06T 2207/10088; G06T 2207/20221; G06T 2207/20081; G06T 2207/30081

(57) ABSTRACT

A method for deformable registration involves a reconstruction of a preoperative anatomical image (23) into a preoperative multi-zone image (41) including a plurality of color zones and a reconstruction of an intraoperative anatomical image (33) into an intraoperative multi-zone image (42) including the plurality of color zones, Each color zone represents a different variation of a non-uniform biomechanical property associated with the preoperative anatomical image (23) and the intraoperative anatomical image (33) or a different biomechanical property associated with the preoperative anatomical image (23) and the intraoperative anatomical image (33).

The present invention generally relates to image reconstructions of a preoperative anatomical image (e.g., a computed tomography (“CT”) scan or a magnetic resonance (“MR”) imaging scan of an anatomy) and of an intraoperative anatomical image (e.g., ultrasound (“US”) image frames of an anatomy) to facilitate a reliable registration of the preoperative anatomical image and the intraoperative anatomical image. The present invention specifically relates to zone labeling of an anatomical segmentation of the preoperative anatomical image and the intraoperative anatomical image for facilitating an intensity-based deformable registration of the anatomical images.

A medial image registration of a preoperative anatomical image with an intraoperative anatomical image has been utilized to facilitate image-guided interventional/surgical/diagnostic procedures. The main goal for the medical image registration is to calculate a geometrical transformation that aligns the same or different view of the same anatomical object within the same or different imaging modality.

An important problem of medical image registration deals with matching images with different modalities sometimes referred to as multi-modality image fusion. Multi-modal image fusion is quite challenging as the relation between the grey values of multi-modal images is not always easy to find and even in some cases, a functional dependency is generally missing or very difficult to identify.

For example, one well-known scenario is the fusion of high-resolution preoperative CT or MR scans with intraoperative ultrasound image frames. For example, conventional two-dimensional (“2D”) ultrasound systems may be equipped with position sensors (e.g., electromagnetic tracking sensors) to acquire tracked 2D sweeps of an organ. Using the tracking information obtained during the image acquisition, the 2D sweep US frames are aligned with respect to a reference coordinate system to reconstruct a three-dimensional (“3D”) volume of the organ. Ultrasound is ideal for intraoperative imaging of the organ, but has a poor image resolution for image guidance. The fusion of the ultrasound imaging with other high-resolution imaging modalities (e.g., CT or MR) has therefore been used to improve ultrasound-based guidance for interventional/surgical/diagnostic procedures. During the image fusion, the target organ is precisely registered between the intraoperative ultrasound and the preoperative modality. While, many image registration techniques have been proposed for the fusion of two different modalities, a fusion of an intraoperative ultrasound with any preoperative modality (e.g., CT or MR) has proven to be challenging due to lack of a functional dependency between the intraoperative ultrasound and the preoperative modality.

In particular, a lack of a functional dependency between MR and ultrasound modalities has made it very difficult to take advantage of image intensity-based metrics for the registration of prostrate images. Therefore, most of the existing registration techniques for MR-to-US image fusion are focused on point matching techniques in two fashions. First, a set of common landmarks that are visible in both modalities (e.g., a contour of urethra) are manually/automatically extracted and used for the point-based registration. Alternatively, a surface of the prostate is segmented within the two modalities using automatic or manual techniques. The extracted surface meshes are fed to a point-based registration framework that tries to minimize the distance between the two point sets.

More particularly, a point-based rigid registration approach may be implemented to register MR with transrectal ultrasound (“TRUS”) surface data. The prostate gland is automatically segmented as a surface mesh in both US and MR images. The rigid registration tries to find the best set of translation and rotation parameters that minimizes the distance between the two meshes. However, one should note that the prostate is not a rigid shape. The shape of the prostate may deform differently during the acquisition of each of these modalities. For example, MR images are typically acquired while an Endorectal coil (“ERC”) is inserted in the rectum for enhanced image quality. On the other hand, the TRUS imaging is performed freehand and the TRUS probe is required to put in direct contact with the rectum wall adjacent to the prostate gland. This direct contact causes deformation of the shape of the prostate during the image acquisition.

One approach to improving the MR-to-US image fusion accuracy during a prostate biopsy includes a nonlinear surface-based rigid registration that assumes a uniformity of the deformation across the prostrate. However, a rigid registration only compensates for translation and rotation mismatching between the MR and US point-sets and therefore, as a result of deformations caused by the TRUS probe and ERC, a rigid transformation is ineffective for matching the two segmented point-sets. Moreover, even if a nonlinear surface-based approach is adapted for the image fusion, a surface-based approach may be sufficient enough to match the two modalities on the surface of the prostate yet such mapping from surface to surface does not provide any information on how to match the internal structures within the prostate gland. More importantly, the assumption of uniform deformation across the prostrate is inaccurate in view of the prostrate gland consisting of cell types having non-uniform biomechanical properties (e.g., stiffness).

The present invention [DWB1] provides a method and a system of deformable registration that introduces anatomically labeled images entitled “multi-zone images” serving as an intermediate modality that may be commonly defined between a preoperative anatomical image and an intraoperative anatomical image. More particularly, anatomical images from each modality are segmented and labeled to two or more predefined color zones based on different variations of a non-uniform biomechanical property of the anatomy (e.g. stiffness of a prostrate). Each color zone is differentiated from other color zones by a different color property (e.g., intensity value). Alternatively or concurrently, the color zones may be based on different biomechanical properties, uniform or non-uniform, of the anatomy (e.g., stiffness and viscosity of a prostrate).

For example, a prostrate image would be segmented into peripheral zones and central zones in each imaging modality to reconstruct the multi-zones images based on the non-uniform stiffness of a prostrate. In this case, the central zones have a higher stiffness than the peripheral zones and therefore the central zones are labeled via a different intensity value (e.g.: background: 0 intensity value; peripheral zone: 127 intensity value; and central zone: 255 intensity value). Any intensity-based deformable registration technique may then be utilized on the reconstructed multi-zone images to thereby fuse the preoperative-to-intraoperative anatomical images (e.g., a B Spline-based registration with normalized cross-correlation image similarity metric for MR-to-US images). This reconstruction approach may be performed during live registration of the preoperative-to-intraoperative anatomical images or in a training set of preoperative-to-intraoperative anatomical images to establish a mode of deformation for improving live registration of preoperative-to-intraoperative anatomical images.

One form of the present invention is a system for multi-modality deformable registration. The system employs a preoperative workstation (e.g., a CT workstation or a MRI workstation), an intraoperative workstation (e.g., an ultrasound workstation) and an deformable registration workstation. In operation, the preoperative imaging workstation generates a preoperative anatomical image and the intraoperative imaging workstation generates an intraoperative anatomical image. The deformable registration workstation reconstructs the preoperative anatomical image into a preoperative multi-zone image including a plurality of color zones and reconstructs the intraoperative anatomical image into an intraoperative multi-zone image including the plurality of color zones. Each color zone represents a different variation of a non-uniform biomechanical property associated with the preoperative anatomical image and the intraoperative anatomical image or a different biomechanical property associated with the preoperative anatomical image and the intraoperative anatomical image.

A second form of the present invention is a modular network for multi-modality deformable registration. The system employs a preoperative image reconstructor and an intraoperative anatomical image reconstructor. In operation, the preoperative reconstructor reconstructs the preoperative anatomical image into a preoperative multi-zone image including a plurality of color zones, and the intraoperative reconstructor reconstructs the intraoperative anatomical image into an intraoperative multi-zone image including the plurality of color zones. Each color zone represents a different variation of a non-uniform biomechanical property associated with the preoperative anatomical image and the intraoperative anatomical image or a different biomechanical property associated with the preoperative anatomical image and the intraoperative anatomical image.

A third form of the present invention is a method for multi-modality deformable registration. The method involves a reconstruction of a preoperative anatomical image into a preoperative multi-zone image including a plurality of color zones and a reconstruction of an intraoperative anatomical image into an intraoperative multi-zone image including the plurality of color zones. Each color zone represents a different variation of a non-uniform biomechanical property associated with the preoperative anatomical image and the intraoperative anatomical image or a different biomechanical property associated with the preoperative anatomical image and the intraoperative anatomical image.

The foregoing forms and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

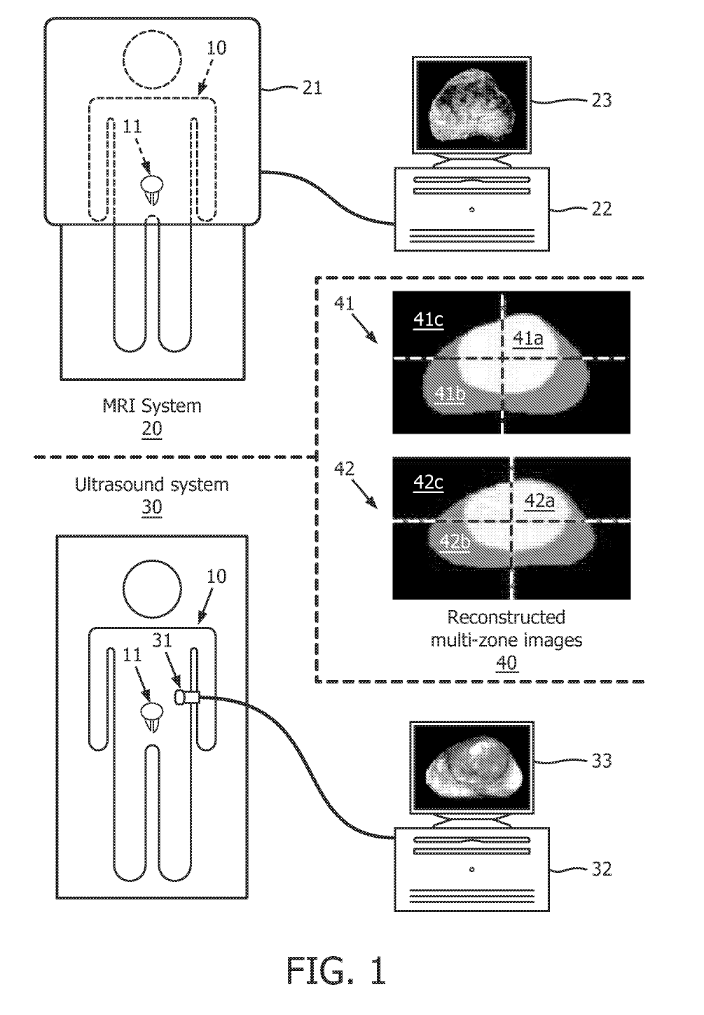

FIG. 1 illustrates reconstructed multi-zone images in accordance with the present invention.

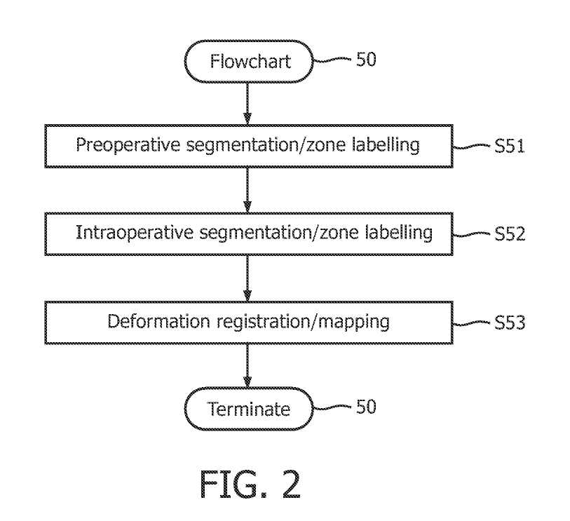

FIG. 2 illustrates a flowchart representative of a first exemplary embodiment of a deformable registration in accordance with the present invention.

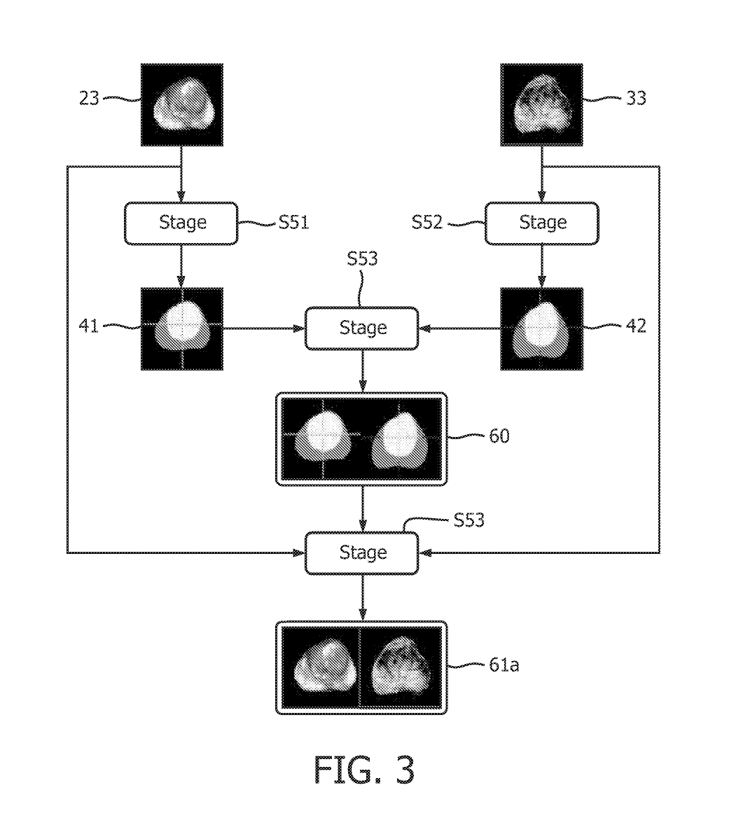

FIG. 3 illustrates an exemplary implementation of the flowchart illustrated in FIG. 2.

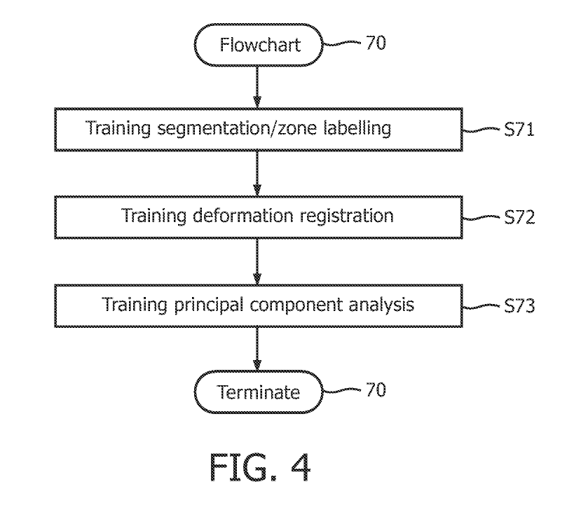

FIG. 4 illustrates a flowchart representative of a first phase of a second exemplary embodiment of a deformable registration in accordance with the present invention.

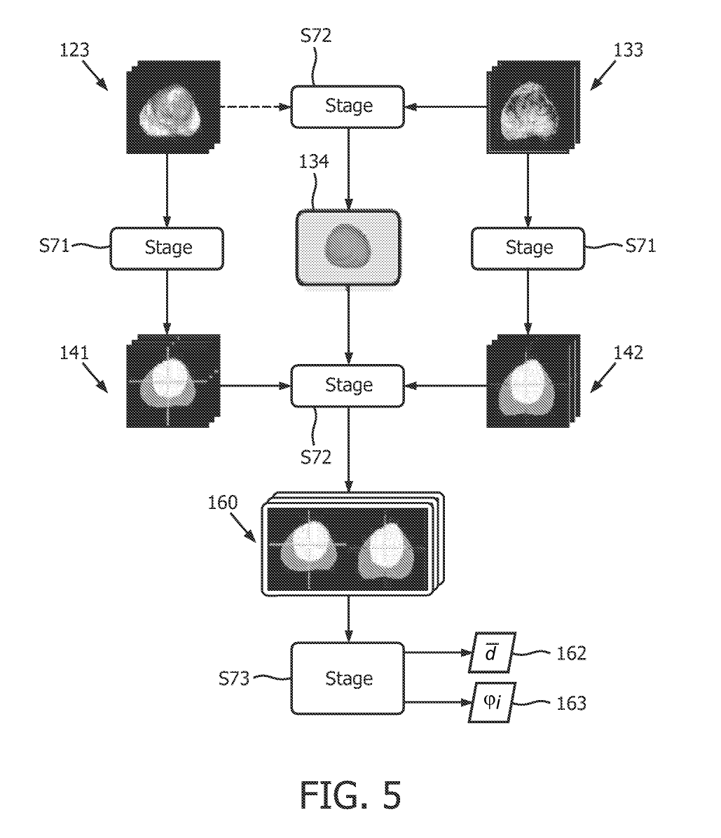

FIG. 5 illustrates an exemplary implementation of the flowchart illustrated in FIG. 4.

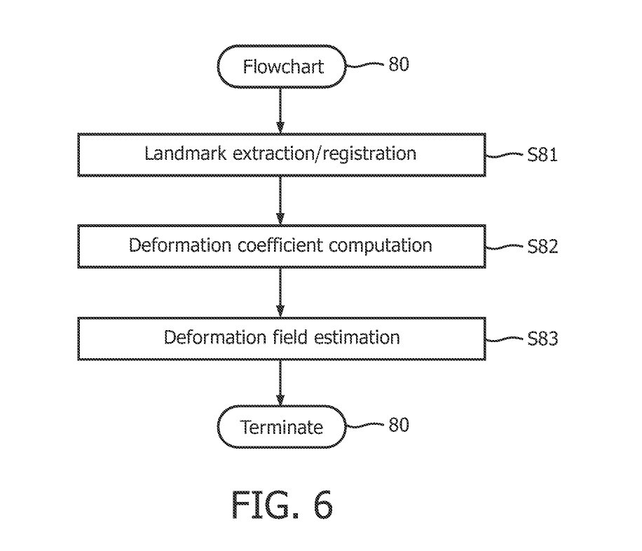

FIG. 6 illustrates a flowchart representative of a second phase of a second exemplary embodiment of a deformable registration in accordance with the present invention.

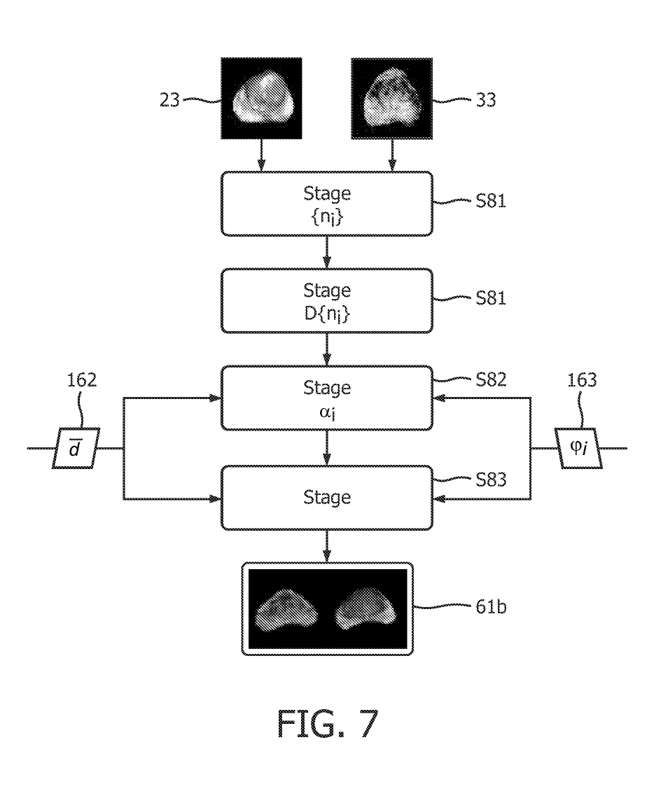

FIG. 7 illustrates an exemplary implementation of the flowchart illustrated in FIG. 6.

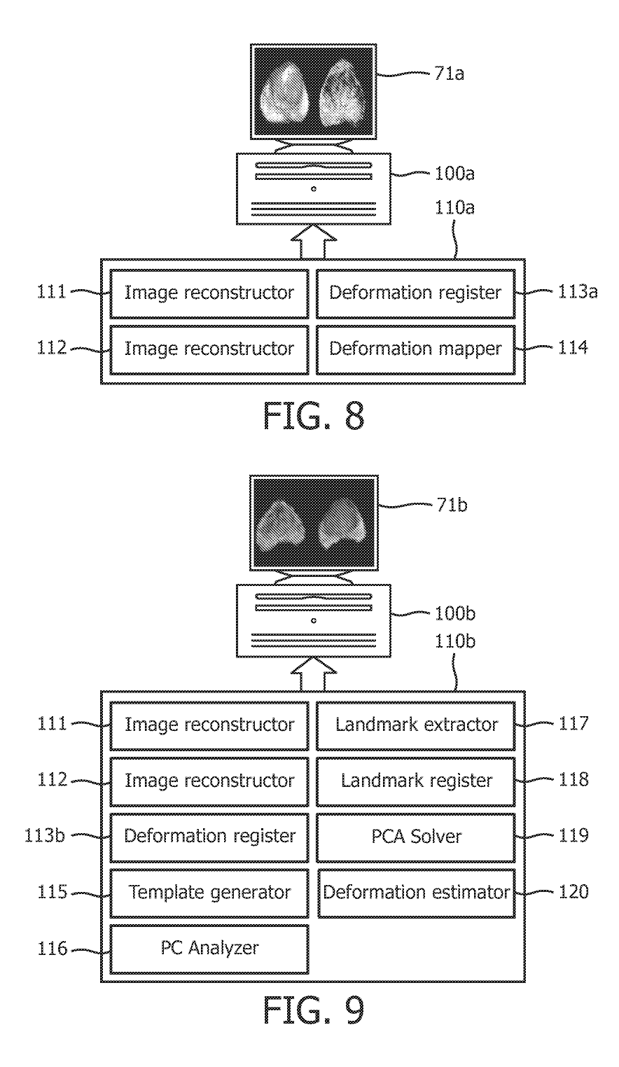

FIG. 8 illustrates an exemplary embodiment of a workstation incorporating a modular network for implementation of the flowchart illustrated in FIG. 2.

FIG. 9 illustrates an exemplary embodiment of a workstation incorporating a modular network for implementation of the flowcharts illustrated in FIGS. 4 and 6.

The present invention utilizes color zones associated with different variations of a non-uniform biomechanical property of an anatomy (e.g., stiffness of a prostrate) to reconstruct multi-zone images as a basis for a deformable registration of anatomical images. Concurrently or alternatively, the color zones may be associated with different biomechanical properties, uniform or non-uniform of the anatomy.

For purposes of the present invention, the terms “ “segmentation”, “registration”, “mapping”, “reconstruction”, “deformable registration”, “deformation field”, “deformation modes” and “principle component” as well as related terms are to be broadly interpreted as known in the art of the present invention.

Also for purposes of the present invention, irrespective of an occurrence of an imaging activity or operation of an imaging system, the term “preoperative” as used herein is broadly defined to describe any imaging activity or structure of a particular imaging modality designated as a preparation or a secondary imaging modality in support of an interventional/surgical/diagnostic procedure, and the term “intraoperative” as used herein is broadly defined to describe as any imaging activity or structure of a particular imaging modality designated as a primary imaging modality during an execution of an interventional/surgical/diagnostic procedure. Examples of imaging modalities include, but are not limited to, CT, MRI, X-ray and ultrasound.

In practice, the present invention applies to any anatomical regions (e.g., head, thorax, pelvis, etc.) and anatomical structures (e.g., bones, organs, circulatory system, digestive system, etc.), to any type of preoperative anatomical image and to any type of intraoperative anatomical image. Also in practice, the preoperative anatomical image and the intraoperative anatomical image may be of an anatomical region/structure of a same subject or of different subjects of an interventional/surgical/diagnostic procedure, and the preoperative anatomical image and the intraoperative anatomical image may be generated by the same imaging modality or different image modalities (e.g., preoperative CT-intraoperative US, preoperative CT-intraoperative CT, preoperative MRI-intraoperative US, preoperative MRI-intraoperative MRI and preoperative US-intraoperative US).

To facilitate an understanding of the present invention, exemplary embodiments of the present invention will be provided herein directed to a deformable registration preoperative MR images and intraoperative ultrasound images of a prostrate. Nonetheless, those having ordinary skill in the art will appreciate how to execute a deformable registration for all image modalities and all anatomical regions.

Referring to FIG. 1, a MRI system 20 employs a scanner 21 and a workstation 22 to generate a preoperative MRI image 23 of a prostate 11 of a patient 10 as shown. In practice, the present invention may utilize one or more MRI systems 20 of various types to acquire preoperative MRI prostrate images.

An ultrasound system 30 employs a probe 31 and a workstation 32 to generate an ultrasound image of an anatomical tissue of prostate 11 of patient 10 as shown. In practice, the present invention utilizes one or more ultrasound systems 30 of various types to acquire intraoperative US prostrate images.

The present invention performs various known techniques including, but not limited to, (1) image segmentation to reconstruct preoperative MR prostrate image 23 of prostrate 11 and intraoperative ultrasound anatomical image of prostrate 11 into multi-zone images including a plurality of color zones and (2) intensity-based deformable registration for a non-linear deformation mapping of the reconstructed multi-zone images. Specifically, an anatomical structure may have a non-uniform biomechanical property including, but not limited to, a stiffness of the anatomical structure, and the non-uniform nature of the biomechanical property facilitates a division of the anatomical structure based on different variations of the biomechanical property. For example, prostrate 11 consists of different cell types that facilitate a division of prostrate 11 into a peripheral zone and a central zone with the central zone having a higher level of stiffness than the peripheral zone. Accordingly, the present invention divides prostrate 11 into these zones with a different color property (e.g., intensity value) for each zone and reconstructs multi-zone images from the anatomical images.

For example, as shown in FIG. 1, a preoperative multi-zone image 41 is reconstructed from preoperative MR prostrate image 23 and includes a central zone 41a of a 255 intensity value (white), a peripheral zone 41b of a 127 intensity value (gray) and a background zone 41c of a zero (0) intensity value (black). Similarly, an intraoperative multi-zone image 42 is reconstructed from intraoperative US prostrate image 33 and includes a central zone 42a of a 255 intensity value (white), a peripheral zone 42b of a 127 intensity value (gray) and a background zone 42c of a zero (0) intensity value (black). The multi-zone images 41 and 42 are more suitable for a deformable registration than anatomical images 23 and 33 and serve as a basis for registering anatomical images 23 and 33.

A description of two embodiments of deformable registration of multi-zone images 41 and 42 as a basis for registering anatomical images 23 and 33 will now be provided herein.

The first embodiment as shown in FIGS. 2 and 3 is directed to a direct deformable registration of anatomical images 23 and 33.

Referring to FIGS. 2 and 3, a flowchart 50 represents the first embodiment of a method for deformable registration of the present invention. A stage S51 of flowchart 50 encompasses an image segmentation of the prostrate illustrated in preoperative MR prostrate image 23 and a zone labeling of the segmented prostrate, manual or automatic, to reconstruct preoperative multi-zone image 41 as described in connection with FIG. 1. In practice, any segmentation technique(s) and labeling technique(s) may be implemented during stage S51.

A stage S52 of flowchart 50 encompasses an image segmentation of the prostrated illustrated in intraoperative US prostrate image 33 and a zone labeling of the segmented prostrate, manual or automatic, to reconstruct intraoperative multi-zone image 42 as described in connection with FIG. 1. In practice, any segmentation technique(s) and any labeling technique(s) may be implemented during stage S51.

A stage S53 of flowchart 50 encompasses a deformable registration 60 of the multi-zone images 41 and 42, and a deformation mapping 61a of prostrate images 23 and 33 derived from a deformation field of the deformable registration 60 of multi-zone images 41 and 42. In practice, any registration and mapping technique(s) may be implemented during stage S53. In one embodiment, of stage S53, a nonlinear mapping between multi-zone images 41 and 42 for the whole prostate gland is calculated using any intensity-based deformable registration (e.g., B Spline-based registration with normalized cross-correlation image similarity metric) and a resulting deformation field is applied to prostrate images 23 and 33 to achieve a one-to-one mapping of the prostate gland between prostrate images 23 and 33. The result is a deformable registration of prostrate images 23 and 33.

FIG. 8 illustrates a network 110a of hardware/software/firmware modules 111-114 are shown for implementing flowchart 50 (FIG. 2).

First, a preoperative image reconstructor 111 employs technique(s) for reconstructing preoperative MR anatomical image 23 into preoperative multi-zone image 41 as encompassed by stage S51 of flowchart 50 and exemplarily shown in FIG. 3.

Second, an intraoperative anatomical image reconstructor 112 employs technique(s) for reconstructing intraoperative US anatomical image 33 into intraoperative multi-zone image 42 as encompassed by stage S52 of flowchart 50 and exemplarily shown in FIG. 3.

Third, a deformation register 113a employs technique(s) for executing a deformable registration of multi-zone images 41 and 42 as encompassed by stage S53 of flowchart 50 and exemplarily shown in FIG. 3.

Finally, a deformation mapper 114 employs technique(s) for executing a deformation mapping of anatomical images 41 and 42 based on a deformation field derived by deformation mapper 113a as encompassed by stage S53 of flowchart 50 and exemplarily shown in FIG. 3.

FIG. 8 further illustrates a deformable registration workstation 100a for implementing flowchart 50 (FIG. 2). Deformable registration workstation 100a is structurally configured with hardware/circuitry (e.g., processor(s), memory, etc.) for executing modules 111-114 as programmed and installed as hardware/software/firmware within workstation 100a. In practice, deformable registration workstation 100a may be physically independent of imaging workstations 20 and 30 (FIG. 1) or a logical substation physically integrated within one or both imaging workstations 20 and 30.

The second embodiment as shown in FIGS. 4-7 is directed to a training set of prostrate images in order to establish a model of deformation to improve deformable registration of anatomical images 23 and 33.

This embodiment of deformable registration is performed in two phases. In a first phase, training sets of prostrate images are utilized to generate a deformation model in the form of a mean deformation and a plurality of deformation mode vectors. In a second phase, mean deformation and a plurality of deformation mode are utilizes to estimate a deformation field for deforming preoperative MR prostate image 23 to intraoperative prostrate image 33.

Referring to FIGS. 4 and 5, a flowchart 70 represents the first phase. For this phase, a population of subjects with each subject providing a preoperative MR prostate image and an intraoperative US prostate image to respectively form a MR training dataset and a US training dataset of prostrate images.

A stage S71 of flowchart 70 encompasses an image segmentation and zone labeling, manual or automatic, of training dataset 123 of preoperative MR prostrate images, which may include preoperative MR prostate image 23 (FIG. 1), to reconstruct a preoperative training dataset 141 of preoperative multi-zone images as described in connection with FIG. 1. In practice, any segmentation technique(s) and labeling technique(s) may be implemented during stage S51.

Stage S71 of flowchart 70 further encompasses an image segmentation and zone labeling, manual or automatic, of training dataset 133 of intraoperative US prostrate images, which may include intraoperative US prostate image 33 (FIG. 1), to reconstruct an intraoperative training dataset 142 of intra operative multi-zone images as described in connection with FIG. 1. Again, in practice, any segmentation technique(s) and labeling technique(s) may be implemented during stage S71.

A stage S72 of flowchart 70 encompasses a training deformable registration of training multi-zone image datasets 141 and 142. In practice, any deformable restriction technique(s) may be implemented during stage S73. In one embodiment of stage S72, intraoperative training multi-zone image dataset 142 is spatially aligned to an ultrasound prostrate template 134, which is an average of intraoperative training dataset 133, and then deformably registered with preoperative training multi-zone image dataset 141. The result is a training dataset 160 of deformable registrations of training multi-zone image datasets 141 and 142.

Alternatively, MR prostate template (not shown) may be generated as an average of training dataset 123 of MR prostate images and then spatially aligned with of intraoperative training dataset 141 of MR prostate images prior to an execution of a deformable registration of training datasets 141 and 142.

The spatial alignment of template 134 to training dataset 142 may be performed using rigid transformation, affine transformation or a nonlinear registration or a combination of the three (3) registration, and the deformable registration of training datasets 141 and 142 may be performed using an intensity-based metric. After the spatial alignment of training dataset 142 to template 134, training dataset 141 is nonlinearly warped to training dataset 142 for each subject. The nonlinear warping may be performed using a B-Spline registration technique with an intensity-based metric. Alternatively, another nonlinear estimation technique such as a finite element method may be used to warp training dataset 141 to training dataset 142 for each subject to obtain a deformation field for the prostate of each subject. The formula for the deformation field is the following:

\tilde{d}^{<i>}=d^{<i>}−d̅ (Eq. 1)

where d^{<i>} and d̅ stand for deformation field resulting from the nonlinear registration of multi-zone images for sample training data i and mean deformation field, respectively.

A stage S73 of flowchart 70 encompasses a principal component analysis training dataset 160 of deformable registrations of training multi-zone image datasets 141 and 142. Specifically, a mean deformation 162 is calculated and principal component analysis (PCA) is used to derive deformation modes 163 from the displacement fields of the subjects used in the first (model) phase of the multi-modal image registration.

The mean deformation 162 is calculated by averaging the deformations of the plurality of subjects:

$$\overline{d} = \frac{1}{n} {\sum }_{i = 1}^{n} {d}^{< i >} \qquad ( Eq . 2 )$$

Where n is the number of data sets or samples or imaged subject, and i=1, 2, . . . , n refers to the indices of the data sets.

The PC analysis is used to derive the deformation modes 163 from the displacement fields of the sample images, as follows. If the calculated displacement fields (with three x, y, z components) are D_{i(m×3)}. Each deformation field is reformatted to a one dimensional vector by concatenating x, y, z components from all data points for the data set.

The covariance matrix Σ is calculated as follows:

Σ=D^{T}D (Eq. 3)

where D_{3m×n}=[\tilde{d}^{<i>}\tilde{d}^{<2>} . . . \tilde{d}^{<n>}]

The matrix of deformation eigenvectors, Ψ, which diagonalize the covariance matrix Σ is found as:

Ψ⁻¹ΣΨ=Λ (Eq. 4)

Where Λ=|λᵢ|_{n×n} is a diagonal matrix with eigenvalues of Σ, as its diagonal elements.

The Eigen vectors of the displacement field matrix (D_{m×n}), where m is the number of data points in a data set is found by:

Φᵢ=D Ψ Λ^{-1/2}. (Eq. 5)

Any displacement field can be estimated from the linear combination of the mean deformation plus the linear combination of the deformation modes (φᵢ) as follows:

$${\hat{d}}^{< j >} = \overline{d} + {\sum }_{i = 1}^{k} {α}_{i}^{< j >} {ϕ}_{i} \qquad ( Eq . 6 )$$

Where k is the number of deformation modes and k<<n.

Referring to FIGS. 6 and 7, a flowchart 80 represents the second phase for estimating a deformation field according to an embodiment of the present invention.

A stage S81 of flowchart 80 encompasses an extraction of landmarks from prostate images 23 and 33 or alternatively, prostate images from a different subject. The landmarks may be any landmarks visible in both prostate images 23 and 33, such as the contour of the urethra or prostate surface contour points, for example. The points for the landmarks in each image may be extracted using any known point extraction method, such as intensity-based metrics, for example. The number of points extracted is preferably sufficient to solve for the Eigen values (or Eigen weights or Eigen coefficients) for all of the deformation modes of flowchart 70.

A stage S82 of flowchart 80 registers the extracted landmark between prostate images 23 and 33 to determine a transformation matrix for the landmark points. This transformation matrix will only be accurate for the landmarks, and will not compensate for the various deformation modes internal to the body structure of the prostate.

A stage S83 of flowchart 80 uses the calculated deformation field for matching landmark points with the mean deformation 162 and the Eigen vectors 1633 from the deformation model calculated in flowchart 70 to calculate Eigen coefficients αᵢ for each deformation mode i where i=1, 2, . . . , k. The Eigen coefficients αᵢ are calculated as follows.

d^{<J>}{S}=d{S}+Σᵢ₌₁^{k} αᵢ^{<j>}φᵢ{S} (Eq. 7)

where S corresponds to the indices of the set of landmark points.

A stage S83 of flowchart 80 encompasses an estimation of a deformation field for all points in the prostate images 23 and 33 by summing the mean deformation 162 and the weighted deformation modes 163 with the Eigen values as follows.

\hat{d}^{<j>}{P−S}=d̅{P−S}+Σᵢ₌₁^{k} αᵢ^{<j>}αᵢ{P−S} (Eq. 8)

where P corresponds to the all the points in the images.

FIG. 9 illustrates a network 110b of hardware/software/firmware modules 111-120 are shown for implementing flowchart 70 (FIG. 4) and flowchart 80 (FIG. 6).

First, preoperative image reconstructor 111 employs technique(s) for reconstructing preoperative training dataset 123 into preoperative training dataset 141 as encompassed by stage S71 of flowchart 70 and exemplarily shown in FIG. 5.

Second, intraoperative anatomical image reconstructor 112 employs technique(s) for reconstructing intraoperative training dataset 133 into intraoperative training dataset 142 as encompassed by stage S71 of flowchart 70 and exemplarily shown in FIG. 5.

Third, a deformation register 113b employs technique(s) for executing a deformable registration 160 of training datasets 141 and 142 as encompassed by stage S72 of flowchart 70 and exemplarily shown in FIG. 5. Deformation register 113b further employs techniques for spatially aligning one of training datasets 123 and 133 to a template 134.

Fourth, a template generator 115 employs technique(s) for generating template 134 as a MR prostate template or a US prostate template as encompassed by stage S72 of flowchart 70 and exemplarily shown in FIG. 5.

Fifth, a principal component analyzer 116 employs technique(s) for generating a deformation model in the form of a mean deformation 162 and deformation modes 163 as encompassed by stage S73 of flowchart 70 and exemplarily shown in FIG. 5.

Sixth, a landmark extractor 117 employs technique(s) for extracting landmarks from anatomical images 23 and 33 as encompassed by stage S81 of flowchart 80 and exemplarily shown in FIG. 7.

Seventh, a landmark register 118 employs technique(s) for registering the extracted landmarks from anatomical images 23 and 33 as encompassed by stage S81 of flowchart 80 and exemplarily shown in FIG. 7.

Eighth, a principal component analyzing solver 119 employs technique(s) for calculate Eigen coefficients for each deformation mode as encompassed by stage S82 of flowchart 80 and exemplarily shown in FIG. 7.

Finally, a deformation field estimator 120 employs technique(s) for estimating a deformation field as encompassed by stage S83 of flowchart 80 and exemplarily shown in FIG. 7.

FIG. 9 further illustrates a deformable registration workstation 100b for implementing flowcharts 70 and 80. Deformable registration workstation 100b is structurally configured with hardware/circuitry (e.g., processor(s), memory, etc.) for executing modules 111-120 as programmed and installed as hardware/software/firmware within workstation 100b. In practice, deformable registration workstation 100b may be physically independent of the imaging workstations 20 and 30 (FIG. 1) or a logical substation physically integrated within one or both imaging workstations 20 and 30.

Referring to FIGS. 1-9, those having ordinary skill in the art will appreciate numerous benefits of the present invention including, but not limited to, a more accurate and complete deformable registration of images of a deformable anatomy structure.

While various embodiments of the present invention have been illustrated and described, it will be understood by those skilled in the art that the embodiments of the present invention as described herein are illustrative, and various changes and modifications may be made and equivalents may be substituted for elements thereof without departing from the true scope of the present invention. In addition, many modifications may be made to adapt the teachings of the present invention without departing from its central scope. Therefore, it is intended that the present invention not be limited to the particular embodiments disclosed as the best mode contemplated for carrying out the present invention, but that the present invention includes all embodiments falling within the scope of the appended claims.

1. A system for deformable registration, the system comprising:
a preoperative imaging workstation operably configured to generate a preoperative anatomical image;
an intraoperative imaging workstation operably configured to generate an intraoperative anatomical image; and
a deformable registration workstation,
wherein the deformable registration workstation is operably configured to reconstruct the preoperative anatomical image into a preoperative multi-zone image of the preoperative anatomical image including a plurality of color zones,
wherein the deformable registration workstation is further operably configured to reconstruct the intraoperative anatomical image into an intraoperative multi-zone image of the intraoperative anatomical image including the plurality of color zones, and
wherein each color zone represents one of a different variation of a non-uniform biomechanical property associated with the preoperative anatomical image and the intraoperative anatomical image or a different biomechanical property associated with the preoperative anatomical image and the intraoperative anatomical image.

2. The system of claim 1, wherein the deformable registration workstation is further operably configured to deformably register the preoperative multi-zone image and intraoperative multi-zone image.

3. The system of claim 2,
wherein the deformable registration workstation is further operably configured to deformably map the preoperative anatomical image and the intraoperative anatomical image based on a deformable registration of the preoperative multi-zone image and intraoperative multi-zone image.

4. The system of claim 1,
wherein the deformable registration workstation is further operably configured to deformably register a preoperative training set of preoperative multi-zone images and an intraoperative training set of intraoperative multi-zone images;
wherein the preoperative training set includes the pre-operative multi-zone image; and
wherein the intraoperative training set includes the intraoperative multi-zone image.

5. The system of claim 4, wherein the deformable registration workstation is further operably configured to spatially align one of the preoperative training set and the intraoperative training set to training anatomical template prior to a deformable registration of the preoperative training set and the intraoperative training set.

6. The system of claim 4, wherein the deformable registration workstation is further operably configured to generate a deformation model based on a deformable registration of the preoperative training set and the intraoperative training set.

7. The system of claim 6, wherein the deformation model includes a mean deformation and a plurality of deformation mode vectors.

8. The system of claim 6, wherein the deformable registration workstation is further operably configured to estimate a deformation field as function of the deformation model.

9. A modular network for deformable registration, the modular network installed on a deformation workstation, the module network comprising:
a preoperative image reconstructor operably configured to reconstruct a preoperative anatomical image into a plurality of color zones a preoperative multi-zone image of the preoperative anatomical image including a plurality of color zones;
an intraoperative anatomical image reconstructor operably configured to reconstruct an intraoperative anatomical image into an intraoperative multi-zone image of the intraoperative anatomical image including the plurality of color zones; and
wherein the preoperative mill-zone image and the intraoperative multi-zone image serve as a basis for a deformably registration of the preoperative anatomical image; and
wherein each color zone represents one of a different variation of a non-uniform anatomical property associated with the preoperative anatomical image and the intraoperative anatomical image or a different anatomical property associated with the preoperative anatomical image and the intraoperative anatomical image.

10. The modular network of claim 9, further comprising:
a deformation register operably configured to deformably register the preoperative multi-zone image and intraoperative multi-zone image.

11. The modular network of claim 10, further comprising:
a deformation mapper operably configured to execute a deformably map the preoperative anatomical image and the intraoperative anatomical image based on a deformable registration of the preoperative multi-zone image and intraoperative multi-zone image.

12. The modular network of claim 9, further comprising:
a deformation register operably configured to deformably register a preoperative training set of preoperative multi-zone images and an intraoperative training set of intraoperative multi-zone images,
wherein the preoperative training set includes the pre-operative multi-zone image, and
wherein the intraoperative training set includes the intraoperative multi-zone image.

13. The modular network of claim 12, further comprising:
a principal component analyzer operably configured to generate a deformation model based on a deformable registration of the preoperative training set and the intraoperative training set.

14. The modular network of claim 13, wherein the deformation model includes a mean deformation and a plurality of deformation mode vectors.

15. The modular network of claim 13, further comprising:
a deformation field estimator operably configured to estimate a deformation field as function of the deformation model.

16. (canceled)

17. (canceled)

18. (canceled)

19. (canceled)

20. (canceled)
